(19) United States
(12) Patent Application Publication
(10) Pub. No.: US 2011/0189586 A1
(43) Pub. Date: Aug. 4, 2011

(54) Nanometer and sub-micron laminar structure of LaxSryMnOz for solid oxide fuel cells application

(76) Inventors: Youmin Liu, East Palo Alto, CA (US); Zhiwei Cai, Fremont, CA (US)

(21) Appl. No.: 12/658,159

(22) Filed: Feb. 4, 2010

(51) Int. Cl. H01M 8/10

(52) U.S. Cl. 429/495

(57) ABSTRACT

Structures, deposition systems and deposition processes related generally to a solid oxide fuel cells (SOFC) are provided. A nanometer to submicron laminar structure of LaₓSr_{y}MnO_{z} is used as an interconnect layer or interface layer between a cathode and an electrolyte for the SOFCs. The SOFC includes a cathode layer, an interface layer coupled to the cathode layer, and an electrolyte coupled to the interface layer. The interface layer includes a plurality of first layers characterized by a first density interleaved with a plurality of second layers characterized by a second density. The first density is lower than the second density. Furthermore, one of the plurality of the first layers is coupled to the cathode layer. Moreover, one of the plurality of the second layers is coupled to the electrolyte. The laminar structure of LaₓSr_{y}MnO_{z} has been applied to the SOFCs to reduce performance degradation in the SOFCs.

### CROSS-REFERENCES TO RELATED APPLICATIONS

The present application claims benefit under 35 USC 119(e) of U.S. Provisional Application No. 60/211,044, Filed Mar. 26, 2009, entitled “NANOMETER AND SUB-MICRO LAMINAR STRUCTURE OF LaₓSr_{y}MnO_{z} FOR SOLID OXIDE FUEL CELLS APPLICATION”, the entire content of which is incorporated herein by reference for all purposes.

### BACKGROUND OF THE INVENTION

The present invention generally relates to a cathode, an electrolyte, and an interface layer between the cathode and electrolyte for solid oxide fuel cells (SOFCs) application. The present invention further relates to the structure of the interface layer.

A solid oxide fuel cell is a device for energy conversion. The solid oxide fuel cell (SOFC) produces direct current electricity through electrochemically reaction. The core of the SOFC is usually a sandwich-like structure, for example, an electrolyte is sandwiched between a cathode and an anode. Each layer of the SOFC may be made from different material. Most SOFCs operate at high temperatures, often higher than 700° C. Under such high temperature operating conditions, elemental diffusion may occur at the interface between the cathode and the electrolyte or substrate. Excess oxidation or corrosion may also occur at the interface between the cathode and the electrolyte. The coefficient of thermal expansion (CTE) mismatch at the interface of the cathode and the electrolyte at the high operating temperatures may also produce microcracks in the structure of SOFCs. Factors including elemental diffusion, excess corrosion or oxidation, and formation of microcracks may cause severe performance degradation in the SOFCs.

Hence, it would be desirable to provide an improved structure of SOFCs that would minimize the performance degradation and provide better results. These issues and others are addressed by the present invention.

### BRIEF SUMMARY OF THE INVENTION

According to embodiments of the present invention, structures, deposition systems and deposition processes related generally to the solid oxide fuel cells (SOFC)s are provided. More particularly, the present invention relates to a nanometer to submicron laminar structure of LaₓSr_{y}MnO_{z} as an interconnect layer or interface layer between a cathode and an electrolyte for the SOFCs. Merely by way of example, the invention of the laminar structure of LaₓSr_{y}MnO_{z} has been applied to the SOFCs to reduce performance degradation in the SOFCs. However, the present invention may have broader applicability. The laminar structure of other materials can also be used in the SOFCs.

According to an embodiment of the present invention, a first solid oxide fuel cell (SOFC) is provided. The first SOFC includes a cathode layer. The first SOFC also includes an interface layer coupled to the cathode layer. The first SOFC further includes an electrolyte coupled to the interface layer. More specifically, the interface layer includes a plurality of first layers characterized by a first density interleaved with a plurality of second layers characterized by a second density. The first density is lower than the second density.

Furthermore, one of the plurality of the first layers of the interface layer is coupled to the cathode layer. Moreover, one of the plurality of the second layers of the interface layer is coupled to the electrolyte.

In a first embodiment, the first layer and the second layer have a thickness ranging from 10 nanometers to 0.4 microns. The interface layer has an overall thickness from 1 micron to 10 microns. In a second embodiment, the first layer contains elements identical to the second layer, although the first layer has different composition ratios of the identical elements from the second layer. In a particular embodiment, both the first layer and the second layer contain elements La, Sr, Mn and O. In a third embodiment, the cathode layer contains the same elements as the interface layer. In a fourth embodiment, the cathode and the interface contain elements La, Sr, Mn and O, where each of the elements has a composition ratio to Mn. The composition ratios of the elements of the cathode and interface vary from La_{0.89}Sr_{0.19}MnO_{3.78} to La_{1.32}Sr_{0.25}MnO_{4.88}. In a fifth embodiment, the interface layer includes at least 4 layers or up to 1000 layers that are interleaved by the first layer and the second layer.

According to another embodiment of the present invention, a second solid oxide fuel cell (SOFC) is provided. The second SOFC includes a cathode having an outside portion and an inside portion that is coupled to the outside portion. The inside portion includes a plurality of first layers characterized by a first density interleaved with a plurality of second layers characterized by a second density. The first density is lower than the second density. Furthermore, one of the plurality of the first layers of the inside portion is coupled to the outside portion of the cathode. The second SOFC also includes an electrolyte coupled to one of the plurality of the second layers of the inside portion of the cathode.

In a further embodiment of the present invention, the cathode including the outside portion and the inside portion has an overall thickness ranging from 2 to 15 microns. In yet another embodiment of the present invention, the outside portion of the cathode comprises the same elements as the inside portion of the cathode. In a particular embodiment, the cathode includes elements La, Sr, Mn and O. In a different embodiment of the present invention, the outside portion of the cathode comprises different elements from the inside portion of the cathode.

Additional embodiments and features are set forth in part in the description that follows, and in part become apparent to those skilled in the art upon examination of the specification or may be learned by the practice of the invention. The features and advantages of the invention may be realized and attained by means of the thin film structures, combinations and methods described in the specification.

### BRIEF DESCRIPTION OF TH DRAWINGS

A further understanding of the nature and advantages of the present invention may be realized by reference to the remaining portions of the specification and the drawings wherein like reference numbers are used throughout the several drawings to refer to similar components.

FIG. 1 illustrates one exemplary SOFC structure according to embodiments of the present invention.

FIG. 2 illustrates another exemplary SOFC structure according to embodiments of the present invention.

FIG. 3 illustrates a deposition system for producing the SOFC structure according to embodiments of the present invention.

FIG. 4 illustrates a flow diagram for illustrating processing steps in producing the SOFC structure according to embodiments of the present invention.

FIG. 5 is a SEM image for an interface laminar structure of over 800 layers in the SOFC according to embodiments of the present invention.

FIG. 6 is a SEM image for an interface laminar structure of four layers in the SOFC according to embodiments of the present invention.

### DETAILED DESCRIPTION OF THE INVENTION

### Solid Oxide Fuel Cell (SOFC)

Solid oxide fuel cells (SOFC)s are characterized by the use of solid oxide material as electrolyte. The electrolyte is a dense layer of oxygen ion conducting ceramic. Its electronic conductivity must be kept as low as possible to prevent losses from leakage currents. The cathode is a thin porous layer on the electrolyte where oxygen reduction takes place. Cathode materials must be at minimum, electronically conductive. Currently, lanthanum strontium manganite (LSM) is the cathode material of choice for commercial use because of its compatibility with doped zirconia or zirconium oxide electrolytes. The anode layer must be very porous to allow fuel to flow toward the electrolyte. Like the cathode, the anode must be electrically conductive. The anode is commonly the thickest and strongest layer in the SOFC, and is often the layer that provides the mechanical support to the SOFC.

### Interface Laminar Structure

The present invention of the interface laminar structure may be used in a conventional solid oxide fuel cell (SOFC). The SOFC includes an anode, an electrolyte adjacent to the anode, an interface adjacent to the electrolyte, and a cathode adjacent to the interface such that the SOFC has a structure of anode/electrolyte/interface/cathode. In a particular embodiment of the present invention, the interface laminar structure may used in a conventional SOFC. The SOFC includes a cathode, an interface laminar structure, and a planar of Fe—Cr alloys. A first side of the interface laminar structure is adjacent to the cathode while a second side of the interface laminar structure is adjacent to the planar of Fe—Cr alloys, such that the interface laminar structure is sandwiched between the cathode and the planar of Fe—Cr alloys which act as electrolyte.

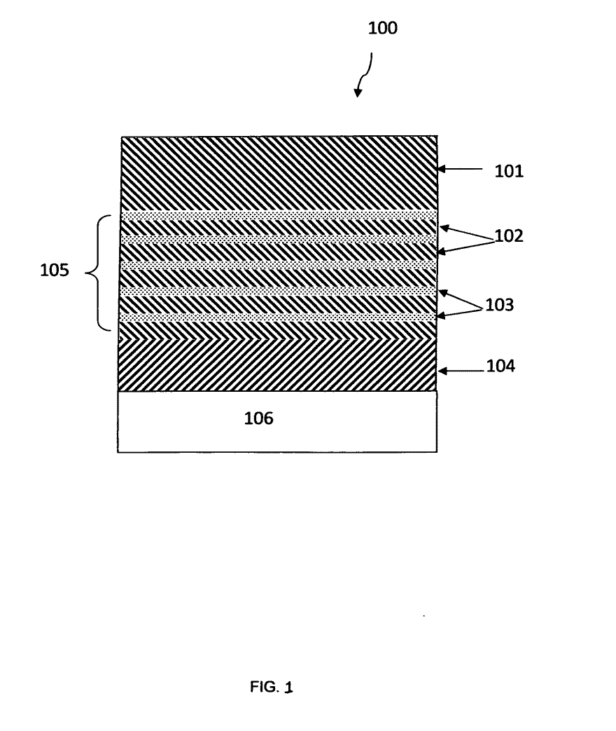

FIG. 1 illustrates a solid oxide fuel cell (SOFC) 100 according to one embodiment of the present invention. The SOFC 100 includes a cathode 101, an interface layer 105, an electrolyte 104, and an anode 106. The interface layer 105 is used as an interconnect layer between the cathode layer 101 and the electrolyte 104. The interface layer 105 includes at least a dense layer 102 that is coupled to the electrolyte 104 and at least a porous layer 103 disposed over the dense layer 102, where the porous layer 103 is coupled to the cathode 101. The dense layer 102 may have a larger density than the porous layer 103.

According to embodiments of the present invention, the interface layer 105 is a thin film having a nanometer or submicron laminar structure that includes alternating dense layers and porous layers. The interface layer 105 may have a thickness varying from a few microns to several tens of microns, such as from 1 μm to 70 μm or even thicker. The dense layer 102 may have a desirable thickness ranging from 30 to 400 nm. The porous layer 103 includes grains of size in the range of nanometers. The porous layer 103 may have a thickness of about 10 nm or greater.

According to an embodiment of the present invention, the porous layers 102 may contain elements identical to the dense layers 103, but may have different composition ratios of the elements. In a particular embodiment, the interface layer 105 may contain the same elements as the cathode. For example, both the interface layer 105 and the cathode 101 may be deposited by using the same target material, such as LaₓSr_{y}MnO_{z}. While the composition ratios of the elements to Mn may vary from different gas environments during deposition. When there is an oxygen rich environment in a processing chamber, oxides with higher oxygen ratio would be formed to result in a porous layer. While the environment in a processing chamber contains less oxygen, a dense layer may be formed with a lower oxygen ratio. The cathode 101 may be made with the same material as the interface or interconnect 105. The cathode 101 may also be made with other materials having functionality and compatibility with SOFCs.

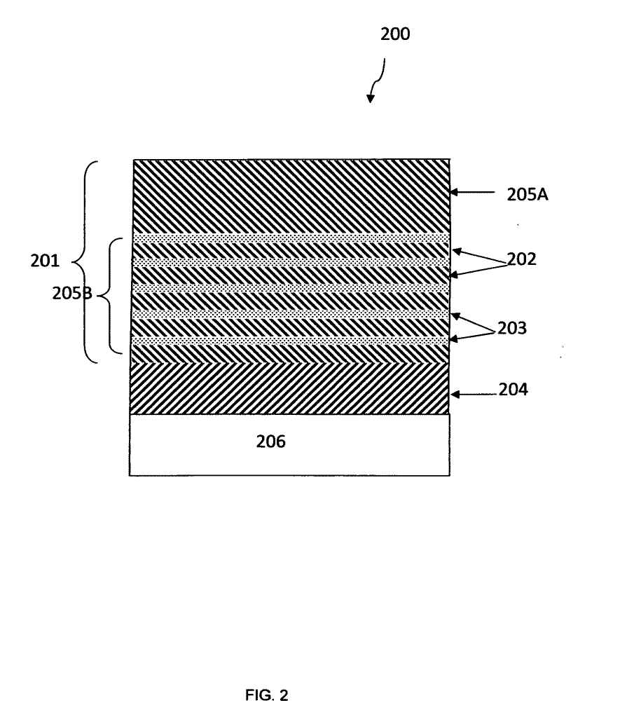

FIG. 2 illustrates another embodiment of the SOFC 200. The SOFC 200 contains a cathode 201 having an outside portion 205A and an inside portion 205B, an electrolyte 204, and a bulk film 206 outside the electrolyte 204. The inside portion 205B includes a nanometer laminar structure between the outside portion 205A of the cathode 201 and the electrolyte 204. The inside portion 205B includes a number of porous layers 202 interleaved with a number of dense layers 203. One of the porous layers 202 of the inside portion 205B is coupled to the outside portion 205A of the cathode 201. One of the dense layers 203 of the inside portion is coupled to the electrolyte 204.

In general, the laminar structure as either an inside portion 205B of the cathode 201, or the laminar structure as the interface layer 105, may have a thickness of 2 to 6 μm. In a specific embodiment, the laminar structure may be around 4 μm thick. The laminar structure 105 or 205B may have at least 4 to 1000 layers that include alternating dense layers 102 and porous layers 103.

### Exemplary Deposition System

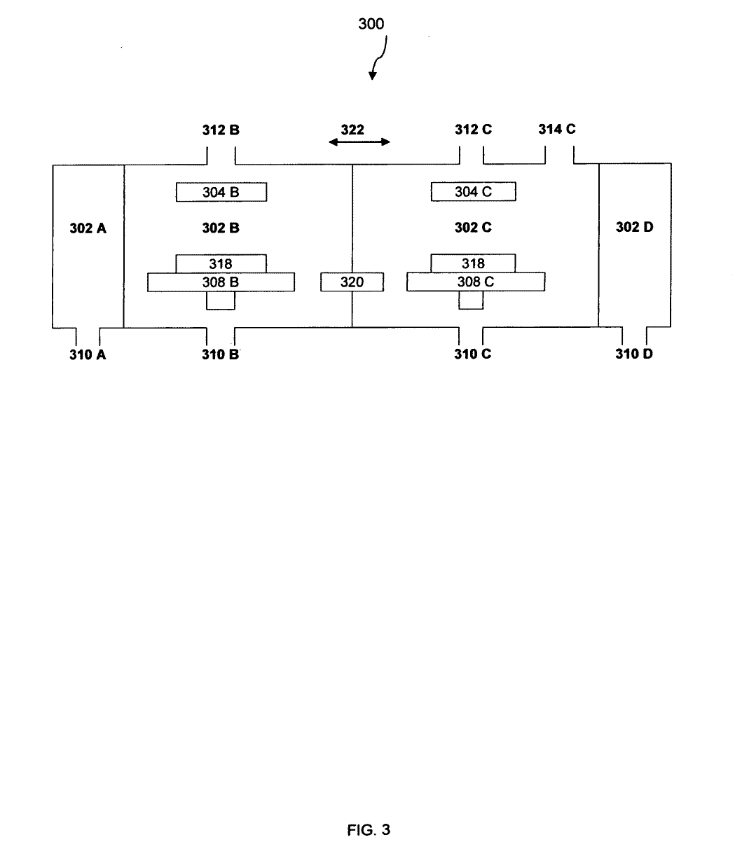

An exemplary deposition system 300 is illustrated in FIG. 3 according to embodiments of the present invention. The exemplary deposition system 300 includes processing chambers 302A-D, deposition sources 304B-C, at least one reaction source 306, and substrate supporting members 308B-C. The system 300 also includes vacuum pumps 310A-D, inert gas inlets 312B-C, and at least one reactant gas inlet 314. The deposition system 300 further includes a transport mechanism 320, which allows the substrate 318 to be transferred from one of the processing chambers 302A-D to another neighboring processing chamber in either direction as pointed by arrow 322. For example, the substrate 318 can be transferred from the processing chamber 302B to the processing chamber 302C, or vice versa. The inert gas inlets 312B-C allow inert gases to flow into the processing chambers 302B-C. The inert gases may include, but not limited to, argon, helium etc. The deposition sources 304B-C include target materials, such as LaₓSr_{y}MnO_{z}, among other materials. The target materials may be sputtered and deposited on the substrate 318 that is held on the substrate supporting members 308B-C in either an argon or a mixture of argon and oxygen environment. The substrate 318 includes an electrolyte. The substrate 318 may also include an anode under the electrolyte to support the electrolyte.

Referring to FIG. 3 again, no deposition source or reactant source are coupled to a first processing chamber 302A such that no deposition or reaction would occur. In a second processing chamber 302B, a dense layer 102 or 202 may be deposited over the substrate 318 by sputtering using the deposition source 304B in an argon gas environment. The substrate 318 may be supported by the substrate supporting member 308B. When the dense layer 102 or 202 reaches a desired thickness, the substrate 318 may be transferred to a third processing chamber 302C from the second processing chamber 302B. The substrate 318 may be supported by the substrate supporting member 308C. The third processing chamber 302C includes the deposition source 304C and the reaction source 306. In the third processing chamber 302C, a porous layer 103 or 203 may be deposited over the substrate 318 in a mixture of argon and oxygen environment. When depositions of alternating dense 102 or 202 and porous layers 103 or 203 are completed, the substrate 318 may be transferred to a fourth processing chamber 302D where no deposition source or reactant source is available. The vacuum pumps 310A and 310D are coupled to the first and fourth processing chambers 302A and 302D to control the chamber pressure. The first and fourth processing chambers 302A and 302D may be optional.

### Exemplary Deposition Process

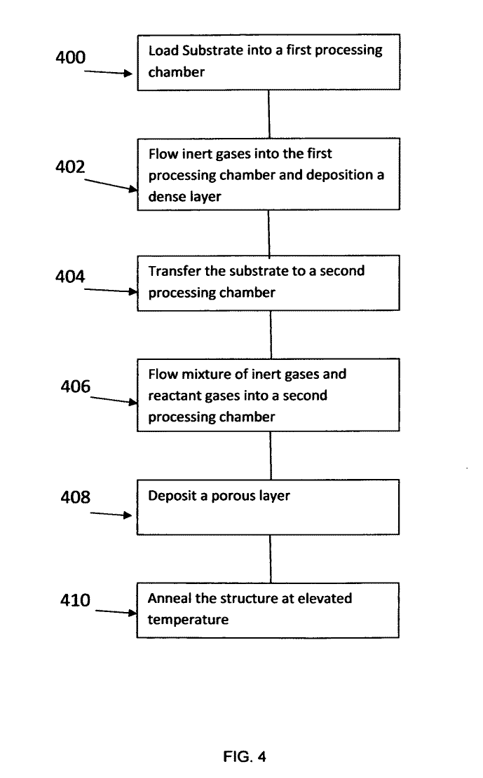

For purposes of illustration, FIG. 4 provides a flow diagram of a process that may be used to form a laminar structure having alternating dense and porous structures interconnected between a cathode and an electrolyte. The laminar structure may also be an inside portion of the cathode. The inside portion is coupled to the electrolyte. The process begins with a substrate being loaded into a first processing chamber as indicated at block 400. Film deposition through sputtering is initiated by flowing inert gases to the first processing chamber at block 402. Such a deposition performed in pure inert gases environment would yield a relatively dense film.

The inert gases may act as a sputtering agent. For example, the inert gases may include heavier inert gas such as argon. The inert gases may also include lighter inert gas such as helium. The level of sputtering provided by the different inert gases is inversely related to their atomic mass. Alternatively, multiple gases may sometimes be provided to the first processing chamber.

The process is followed by transferring the substrate to a second processing chamber at block 404. The next film deposition is initiated by flowing a mixture of inert gases and reactant gases into the second processing chamber at block 406. The reactant gases may include oxygen, ozone or mixture thereof. The inert gases may include argon, helium or mixture thereof. In the second processing chamber, the deposition source or target is the same as used in the first processing chamber. Such deposition performed in a mixture of inert gases and reactant gases would yield a relatively porous film disposed over the dense film that is formed at block 402. The ratio of inert gases to the reactant gases may be varied to control the density of the porous layer. In a specific embodiment, a ratio of Ar to O₂ may be up to 20%.

The process continues by transferring the substrate from the second processing chamber to the first processing chamber at block 408, followed by sputtering deposition in inert gases environment. The process steps at blocks 402-406 may be repeated after the step at block 408 to form a laminar structure of multiple alternating dense and porous layers. The process is then followed by annealing the laminar structure at block 410. Annealing may be performed at elevated temperatures to convert an amorphous laminar structure into a crystalline laminar structure, such as at approximately 900° C.

Alternative deposition methods may be used to fabricate such laminar structures if deposition rates, film densities and film thicknesses can be accurately controlled. One of ordinary skill in the art would recognize many variations, modifications and alternatives.

According to an embodiment of the present invention, the reactant in the chamber of the reaction source 306 may be oxygen O₂. The thickness of the interface laminar structure 105 or 205 may be controlled by varying processing conditions, such as temperature, chamber pressure, sputtering time or reaction time, mixing ratio of inert gases and reactant gases. By adjusting conditions such as temperature, pressure, mixing ratio of the inert gas to the reactant, and reaction time in the processing chamber 302C, the thickness and the density of the porous layers 103 or 203 can be varied. Likewise, by adjusting conditions such as temperature, pressure, and sputtering time in the processing chamber 302B, the thickness of the dense layers 102 or 202 can be changed. Through repeating the deposition processes of the dense layers 102 and the porous layers 103, the laminar structure interface or interconnect 105 or 205 can be made.

In one embodiment, the substrate 318 may not be heated. The argon pressure may be controlled at 1 mTorr. In another embodiment, the substrate 318 may be heated by using a heater 322 to an elevated temperature. In a specific embodiment, the substrate 318 may be heated to about 200° C. The substrate 318 may also be biased by a DC power supply 324, for example, using a DC voltage 200-300 V. The substrate 318 may be 4 inches by 4 inches in a square shape. The substrate 318 may also be in a circular shape.

In a further embodiment, a sputtering power for the deposition source may be supplied by a DC pulse power supply. The sputtering power may be in a range from 2.5 kW to 5 kW.

### Experimental Results

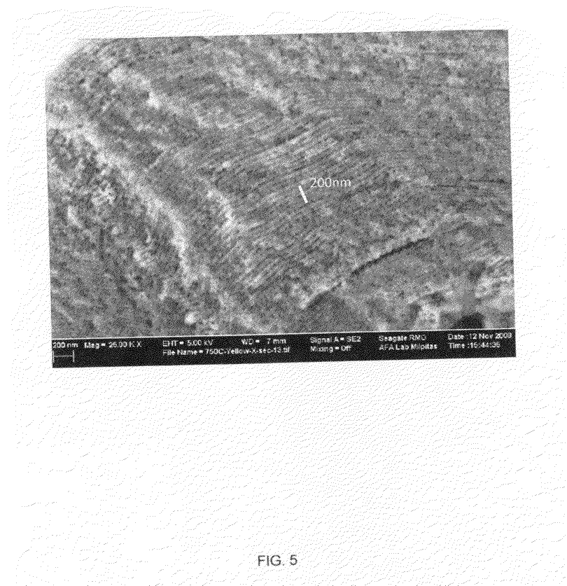

Inventors have performed experiments and demonstrated that significant improvements in the performance of SOFCs were achieved as a result of incorporation of the interface laminar layer 105 or 205 between the cathode 101 or 201 and the electrolyte 104 or 204, compared to traditional SOFCs having similar materials. FIG. 5 illustrates a scanning electron microscope (SEM) image of the interface layer 105 after being annealed at about 900° C. Annealing is used to convert an amorphous sputtering film into a crystalline laminar structure. As shown in FIG. 5, the interface layer or film 105 includes more than 800 alternating dense laminar layer 102 (bright) and porous laminar layer 103 (dark). One dense laminar layer (relatively bright) has a thickness around 35 nm, while one porous layer 103 (relatively darker) has a thickness about 10 nm. The interface layer 105 is about 3-4 μm thick. Such a thin interface film of about 3-4 μm thick could provide better performance than the traditional 60-70 μm thick film of similar material without the laminar structure 105 including alternating porous and dense layers.

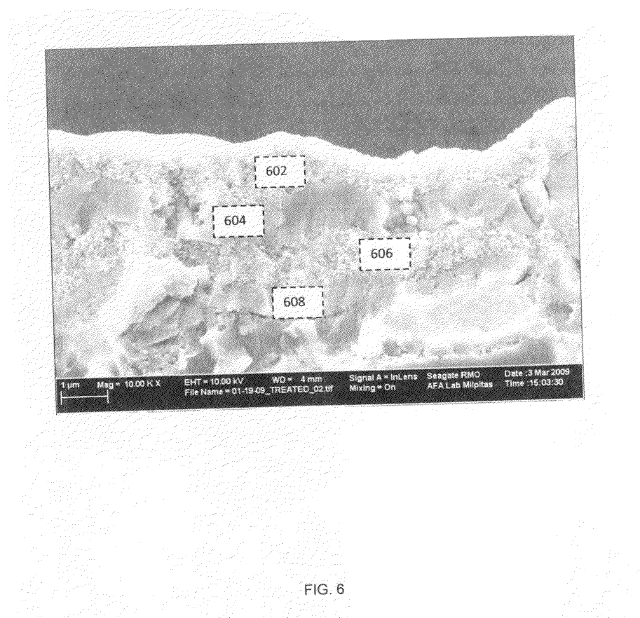

FIG. 6 shows a SEM image of the sub-micron laminar structure of the interface layer 105. The interface includes 4 layers, top 602, second layer 604, third layer 606, and fourth layer 608. The top layer 602 is a porous layer. The second layer 604 under the top layer 602 is a dense layer, where the second or dense layer 604 has a surface morphology different from the top or porous layer 602. The third layer 606 under the dense layer 604 has similar surface morphology to that of the top layer 602, and is a porous layer like the top layer 602. The fourth layer 608 under the porous layer 606 has a similar surface morphology to that of the layer 604 and is a dense layer like the second layer 604. Because of the difference in the surface morphology between the porous layers 602, 606 and the dense layers 604 and 608, the porous layers are characterized by a lower density than the dense layers.

One of the benefits of using the interface laminar structure is that the SOFC structures having an interface layer 105 or 205 reveal greater tolerance for the composition ratio of elements in the cathode and the interface or interconnect. For example, the composition ratio of the elements can vary from La_{0.89}Sr_{0.19}Mn_{1.0}O_{3.78} to La_{1.32}Sr_{0.25}Mn_{1.0}O_{4.88}. More specifically, if the cathode and the interface contain 1 mole of manganese (Mn), they may contain 0.89 to 1.32 mole of lanthanum (La), 0.19 to 0.25 mole of strontium (Sr), and 3.78 to 4.88 mole of oxygen (O). The performance of the SOFC would remain the same for these composition ratios.

Another benefit of using the interface layer with nanometer laminar structures between the cathode and the electrolyte is to achieve improved stability under high temperature operating conditions, such as 800° C. or higher temperatures. For example, after a stability test for a period of 1000 hours at high temperature such as 800° C., no phase separation would occur in lanthanum within the above range of composition ratios. The lanthanum separation is traditionally reported in publications in such high temperature applications.

Additional benefits include that no microcracks were observed in the bulk of the cathode 101 or 201 and the interface layer 105 or 205, perhaps as a result of reduction in thermal stress. The microcracks may result in performance degradation of the SOFCs. The interface layer including alternating dense and porous structures may reduce the thermal stress resulting from mismatch of thermal expansion between the cathode and the electrolyte to minimize microcracks. As described earlier, the cathode 101 or 201 has a porous structure which has a better thermal match with the porous layer 103 or 203 of the interface 105 or 205, while the electrolyte 104 or 204 has a dense structure which has a better match of thermal expansion with the dense layer 102 or 202 of the interface 105 or 205.

Having described several embodiments, it will be recognized by those of ordinary skills in the art that various modifications, alternative constructions, and equivalents may be used without departing from the spirit of the invention. These equivalents and alternatives are intended to be included within the scope of the present invention. Specific parameters can vary for different structures and different processing conditions. Additionally, a number of well-known processes and elements have not been described in order to avoid unnecessarily obscuring the present invention. Therefore, the scope of this invention should not be limited to the embodiments described, but should instead be defined by the following claims.

What is claimed is:

1. A solid oxide fuel cell, comprising:
a cathode layer;
an interface layer coupled to the cathode layer; and
an electrolyte coupled to the interface layer, wherein:
the interface layer comprises a plurality of first layers characterized by a first density interleaved with a plurality of second layers characterized by a second density, wherein the first density is lower than the second density;
one of the plurality of the first layers of the interface layer is coupled to the cathode layer; and
one of the plurality of the second layers of the interface layer is coupled to the electrolyte.

2. The solid oxide fuel cell of claim 1 further comprises an anode coupled to the electrolyte.

3. The solid oxide cell of claim 1, wherein the first layer and the second layer have a thickness ranging from 10 nanometers to 0.4 microns.

4. The solid oxide cell of claim 1, wherein the interface layer has an overall thickness from 1 to 10 microns.

5. The solid oxide cell of claim 1, wherein the first layer comprises elements identical to the second layer.

6. The solid oxide cell of claim 5, wherein the first layer has different composition ratios of the elements from the second layer.

7. The solid oxide cell of claim 5, wherein the first layer and the second layer comprises elements La, Sr, Mn and O.

8. The solid oxide cell of claim 1, wherein the cathode layer comprises the same elements as the interface layer.

9. The solid oxide cell of claim 8, wherein the cathode layer and the interface comprise elements La, Sr, Mn and O, wherein each of the elements has a composition ratio to Mn.

10. The solid oxide cell of claim 9, wherein the composition ratios of the cathode and the interface vary from La_{0.89}Sr_{0.19}MnO_{3.78} to La_{1.32}Sr_{0.25}MnO_{4.88}.

11. The solid oxide cell of claim 1, wherein the interface layer comprises at least 4 layers that are interleaved by the first layer and the second layer.

12. The solid oxide cell of claim 1, wherein the interface layer comprises up to 1000 layers that are interleaved by the first layer and the second layer.

13. The solid oxide cell of claim 1, wherein the electrolyte comprises an alloy of Fe and Cr.

14. A solid oxide fuel cell, comprising:
a cathode comprising an outside portion and an inside portion that is coupled to the outside portion; wherein:
the inside portion comprises a plurality of first layers characterized by a first density interleaved with a plurality of second layers characterized by a second density;
the first density is lower than the second density; and
one of the plurality of the first layers of the inside portion is coupled to the outside portion of the cathode; and
an electrolyte coupled to one of the plurality of the second layers of the inside portion of the cathode.

15. The solid oxide cell of claim 14, wherein the cathode comprising the outside portion and the inside portion has an overall thickness ranging from 2 to 15 microns.

16. The solid oxide cell of claim 14, wherein the outside portion of the cathode comprises the same elements as the inside portion of the cathode.

17. The solid oxide cell of claim 16, wherein the cathode comprises elements La, Sr, Mn and O.

18. The solid oxide cell of claim 14, wherein the outside portion of the cathode comprises different elements from the inside portion of the cathode.
